(19) United States
(12) Patent Application Publication
(10) Pub. No.: US 2014/0231307 A1
(43) Pub. Date: Aug. 21, 2014

(54) METHOD AND APPARATUS FOR TOOL CASE

(71) Applicant: Hao Wen, Shanghai (CN)

(72) Inventor: Hao Wen, Shanghai (CN)

(73) Assignee: SHANGHAI KUNJEK HANDTOOLS AND HARDWARE CO., LTD., Shanghai (CN)

(21) Appl. No.: 14/351,847

(22) PCT Filed: Jun. 26, 2012
(86) PCT No.: PCT/CN2012/077563

§ 371 Date: Apr. 14, 2014

(30) Foreign Application Priority Data
Oct. 17, 2011 (CN) 201120394590.2

(51) Int. Cl. B25H 3/02

(52) U.S. Cl. CPC B25H 3/02
USPC 206/736

(57) ABSTRACT

A tool case for convenient display is provided. The tool case includes a lid, a body, and a flip display connector. The lid and the body are connected in a flipping manner via the flip display connector. The flip display connector includes a connector main body, a first pin, and a second pin. The connector main body has two parallel through holes, each pin passing through a corresponding parallel through hole. The lid may rotate 360 degrees relative to the body, thus, may be flipped over for conveniently displaying tools in the tool case. A method of displaying the contents of a tool case is provided. The method comprises the following steps of: a) opening the tool case; b) rotating the lid about 360 degrees relative to the body to a fully open position; c) locking the lid to the body in the fully open position.

### CROSS-REFERENCE TO RELATED APPLICATIONS

This application claims benefit of Chinese Patent Application Serial No. 201120394590.2, filed Oct. 17, 2011, the contents of which are herein incorporated by reference in its entirety.

### BACKGROUND OF THE INVENTION

1. Field of the Invention

Embodiments of the invention relate to methods and apparatus for a tool case (also referred to herein as a toolbox), and more specifically, a tool case for convenient display.

2. Description of the Related Art

Toolboxes include a box body and a box lid hingedly connected to the box body. However, in existing toolboxes, the box lid generally only rotates about 180 degrees when opened. Existing toolboxes thus are not convenient or adapted to display or show the tools disposed therein. At the same time, existing toolboxes occupy large spaces because the box lid cannot be folded relative to the tool body when opened.

Therefore, there is a need for a new tool case that can conveniently display the contents therein, while minimizing spatial requirements.

### SUMMARY OF THE INVENTION

Embodiments of the invention include a tool case that is convenient for displaying tools therein. Embodiments of the invention overcome the problems of existing toolboxes, the problems including not being convenient for displaying tools and occupying large spaces when the box lid is opened relative to the box body.

To solve the above problems, the embodiments of the invention provide a tool case for convenient display. The tool case includes a lid, a body, and a flip display connector. The lid and body are connected in flipping manner via the flip display connector.

In one embodiment, the flip display connector includes a connector main body pivotably connected to the lid and the body respectively.

In one embodiment, the flip display connector further includes a first pin and a second pin. The connector main body has two parallel through holes. Each pin passes through a through hole of the connector main body. The first pin connects to the body and the second pin connects to the lid.

In one embodiment, a distance of an axis of the first pin and an axis of the second pin is not less than a half of the summation of a height of the body and a height of the lid.

In one embodiment, the flip display connector further includes a body base and a lid base. The body base is disposed on the body. The lid base is disposed on the lid. The connector main body is disposed within the two bases.

In one embodiment, the body has a first cavity volume at a connecting region. The body base is disposed within the first cavity volume. The body base has a concaved first load slot. The connector main body is connected within the first load slot and the body base is fixedly coupled to the body via the first pin.

In one embodiment, the lid has a second cavity volume at a connecting region. The lid base is disposed within the second cavity volume. The lid base has a concaved second load slot. The connector main body is connected within the second load slot and the lid base is fixedly coupled to the lid via the second pin.

In one embodiment, a top side and a bottom side of the lid have the same structures.

In one embodiment, a top side and a bottom side of the body have the same structures.

In one embodiment, corresponding handles are positioned on front ends of the body and the lid.

Embodiments of the invention provide a tool case that is convenient for display wherein a lid can rotate 360 degrees relative to a body, and thus may be flipped, thereby reducing the space needed when opening the lid. After the lid is flipped, the tool case may be stood upright for the purpose of displaying tools disposed in the tool case. Top and bottom sides of the lid may have the same structures, and top and bottom sides of the body may have the same structures. The tool case can continue to function as a tool case when the lid is flipped over, thus, extending the life time of the tool case. A handle is respectively disposed on a front end of the lid and on a front end of the body. The two handles overlap and can be stacked for convenient carrying and preventing tools from falling out. Additionally, the overlapped handles may used for hanging the tool case during display.

In one embodiment, a tool case for convenient display may comprise a lid; a body; and a hinge coupled to the lid and the body, wherein the lid and the body are rotatable about the hinge and relative to each other through an angle greater than 180 degrees.

In one embodiment, a tool case for convenient display may comprise a lid; a body; and a hinge pivotably coupled to the lid by a first pin connection, and pivotably coupled to the body by a second pin connection, wherein the hinge is operable to rotate the lid relative to the body through an angle greater than 180 degrees.

In one embodiment, a tool case for convenient display may comprise a lid having an inner surface; a body having an inner surface; and a hinge coupled to the lid by a first pivotable connection, and coupled to the body by a second pivotable connection, wherein the hinge is operable to rotate the lid relative to the body to a closed position such that the inner surfaces face toward each other, and to an open position such that the inner surfaces face away from each other in opposite directions.

In one embodiment, a tool case for convenient display may comprise a lid; a body; and a hinge pivotably coupled to the lid and the body by separate pivotable connections, wherein the hinge is operable to flip the lid relative to the body such that the lid is engagable with a first side of the body and a second opposite side of the body.

In one embodiment, a method of displaying the contents of a tool case comprise opening the tool case, wherein the tool case includes a lid, a body, and a hinge pivotably connected to the lid and the body; rotating the lid about 360 degrees relative to the body to a fully open position; locking the lid to the body in the fully open position; and standing the tool case on the edges of the lid and the body when in the fully open position to display tools supported by at least one of the lid and the body.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic exploded view of a tool case in an open position according to one embodiment.

FIG. 2 is a schematic assembled view of the tool case in the open position according to one embodiment.

FIG. 3 is a schematic exploded view of the tool case in a closed position according to one embodiment.

FIG. 4A is a schematic view of the tool case opened at an angle showing the interior of the tool case.

FIG. 4B is a schematic view of the tool case opened at an angle showing the exterior of the tool case.

### DETAILED DESCRIPTION

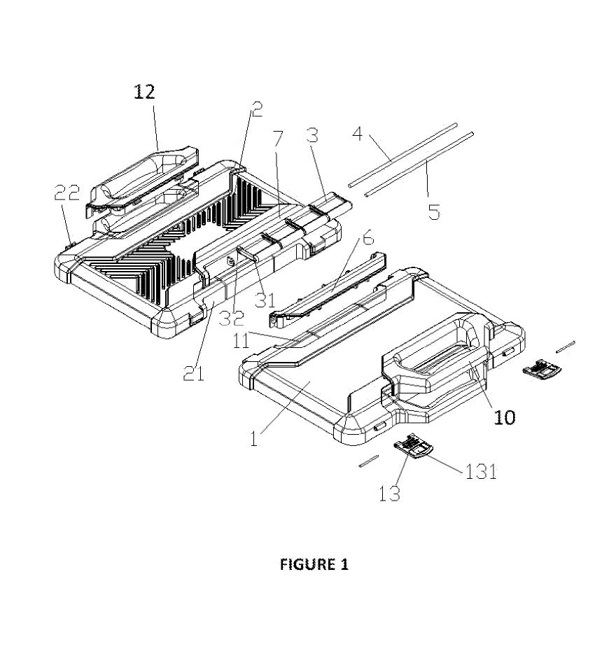

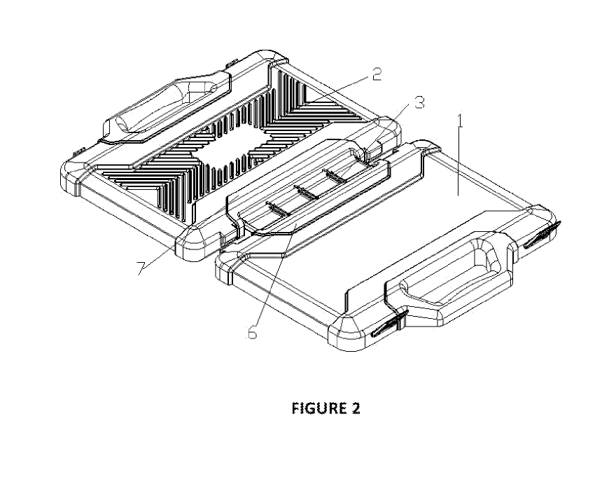

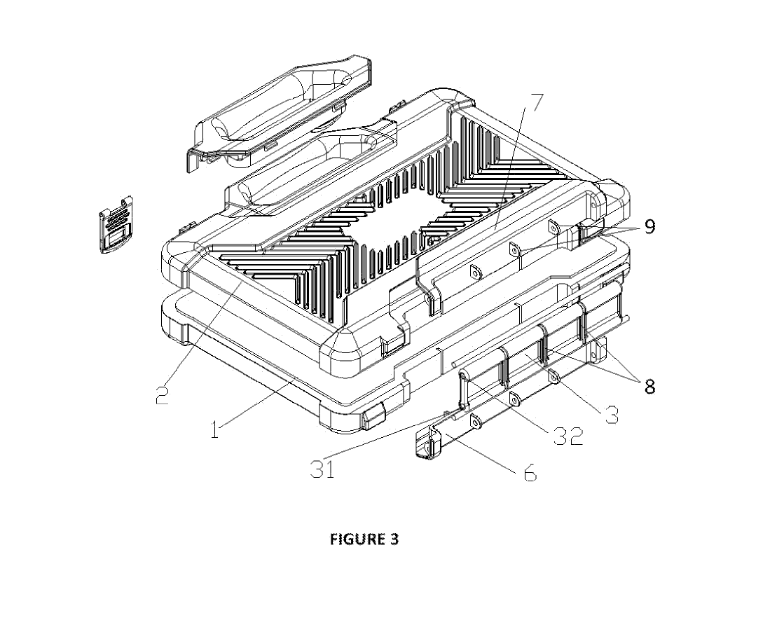

Referring to FIG. 1, FIG. 2 and FIG. 3, embodiments of the invention include a tool case for convenient display. The tool case includes a lid 1 and a body 2. The tool case also includes a hinge, referred to herein as a flip display connector and generally identified as reference numeral items 3, 4, 5, 6, and 7 in FIGS. 1-3. The lid 1 and body 2 are connected by the flip display connector. The lid 1 can rotate relative to the body 2 (or vice versa) and about the hinge through an angle greater than 180 degrees, such as through a 360 degree angle, and can be flipped or moved open to a position adjacent to a bottom surface of the body 2 to display the tools inside the tool case. When the tool case is in the fully closed position, the inner surfaces of the lid 1 and the body 2 are adjacent and facing toward each other, and may be flush or contacting as well. When the lid 1 of the tool case is moved to its fully open position, e.g. when it is flipped or rotated about 360 degrees relative to the body 2, then the inner surfaces are facing outward or away from each other and in opposite directions (e.g. the tool case is folded open such that the inner surfaces are now completely facing outward). In the fully open position, the outer surfaces of the lid 1 and the body 2 are adjacent and facing each other, and may be flush or contacting as well (e.g. the tool case is folded open such that the outer surfaces are now completely facing inward). The tool case can be stood on the edges of the lid 1, the body 2, and/or the flip display connector throughout any position within the entire 360 degree range of movement between the lid 1 and the body 2 (e.g. any position between and including the fully open and the fully closed positions) for convenient displaying of the contents therein.

The 360 degree range of motion between the lid 1 and the body 2 is provided by the flip display connector. The flip display connector includes a connector main body 3. The connector main body 3 connects to both the lid 1 and the body 2 at different locations, that is, the connector main body 3 has one portion connected to the lid 1 and another portion connected to the body 2. According to one embodiment, the connector main body 3 includes two parallel through holes, a first parallel through hole 32 and a second parallel through hole 31. The first parallel through hole 32 is used to rotatably connect to the body 2, and the second parallel through hole 31 is used to rotatably connect to the lid 1. The connector main body 3 has a wide footprint, which provides stability to the tool case when in use.

The flip display connector further includes a first pin 4 and a second pin 5. The first pin 4 is used to rotatably connect the connector main body 3 and the body 2. The first pin 4 is inserted or passed though the first parallel through hole 32 of the connector main body 3, and also is inserted or passed through a corresponding hole or connection in the body 2 as further described below. The second pin 5 is used to rotatably connect the connector main body 3 to the lid 1. The second pin 5 is inserted or passed through the second parallel through hole 31 of the connector main body 3, and is also inserted or passed through a corresponding hole or connection in the lid 1 as further described below.

According to one embodiment, the condition to ensure that the body 2 rotates relative to the lid 1 for 360 degrees is: a distance between an axis of the first pin 4 and an axis of the second pin 5 is not less than a half of the summation of a height of the lid 1 and a height of the body 2; or a distance between the first parallel through hole 32 and the second parallel through hole 31 is not less than a half of the summation of the height of the lid 1 and the height of the body 2. This condition enables the flipping of the lid 1 and the flipping of the body 2.

The flip display connector further includes a body base 7 and a lid base 6. The body 2 has a first cavity volume 21 positioned in a region where the body 2 is connected to the lid 1. The body base 7 is disposed within the first cavity volume 21 and may be coupled to the body 2. The body base 7 has a concaved first load slot formed thereon. The first load slot is used to carry the load of the connector main body 3. The connector main body 3 is connected to the body base 7 via the first pin 4, and the body base 7 is fixedly coupled to the body 2 via the first pin 4. The lid 1 has a second cavity volume 11 positioned in a region where the lid 1 is connected to the body 2. The lid base 6 is disposed within the second cavity volume 11 and may be coupled to the lid 1. The lid base 6 has a concaved second load slot formed thereon. The second load slot is used to carry the load of the connector main body 3. The connector main body 3 is connected to the lid base 6 via the second pin 5, and the lid base 6 is fixedly coupled to the lid 1 via the second pin 5. In one embodiment, the body base 7 and/or the lid base 6 may be coupled to the respective body 1 or lid 2 using a connection similar to but separate from the pins 4, 5, such as by another pin connection.

According to one embodiment, the connector main body 3 has a shape of a ladder, that is, the connector main body 3 has a plurality of horizontal members or sticks 8 positioned between the first parallel through hole 32 and the second parallel through hole 31 and perpendicular to the parallel through holes. The plurality of horizontal sticks 8 correspond to and engage a plurality of spacer plates 9 formed in the first load slot of the body base 7 and the second load slot of the lid base 6. The spacer plates 9 are pivotable connected to the horizontal sticks 8 via the first pin 4 or the second pin 5, which pins are disposed through the spacer plates 9 and the horizontal sticks 8. The first pin 4 and the second pin 5 may also extend into corresponding holes formed in the body 2 and the lid 1, respectively, to connect the connector main body 3 and thus the body base 7 or the lid base 6 to the respective body 2 or lid 1. The spacer plate arrangement enables convenient connection of the connector main body 3 with the lid 1 and the body 2, and prevents the connector main body 3 from falling out causing the tool case to fall apart when the lid 1 is flipping relative to the body 2.

According to one embodiment, corresponding handles 10, 12 are positioned on front ends of the lid 1 and the body 2, respectively. The lid 1 and the body 2 have a handle cavity through hole at the same location. The handles 10, 12 are disposed in each of the respective handle cavity through hole for carrying the tool box.

According one embodiment, a clasp or locking mechanism of the tool case may include two inserting members or leaves 22 that protrude from the front end of the body 2, and two locking plates 13 that are positioned on the front end of the lid 1. The locations of the two inserting leaves 22 correspond to the locations of the two locking plates 13. The locking plates 13 may be mounted on the lid 1 through dole pins or other similar connections. The locking plates 13 have slots 131 through which the inserting leaves 22 are inserted. When the inserting leaves 22 are inserted into the slots 131, the lid 1 is locked to the body 2, e.g. secured from rotating relative to the body 2, and the tool case is in a locked position. The tool case may be locked in position using the inserting leaves 22 and the locking plates 13 when the lid 1 is rotated relative to the body 2 into the fully closed position, such that the contents of the tool case are hidden from view. The tool case also may be locked in position using the inserting leaves 22 and the locking plates 13 when the lid 1 is rotated 360 degrees relative to the body 2 into the fully open position, such that the contents of the tool case are fully viewable. The contents of the tool case may be supported by one or more recessed portions formed on the inner surfaces of the lid 2 and/or the body 1.

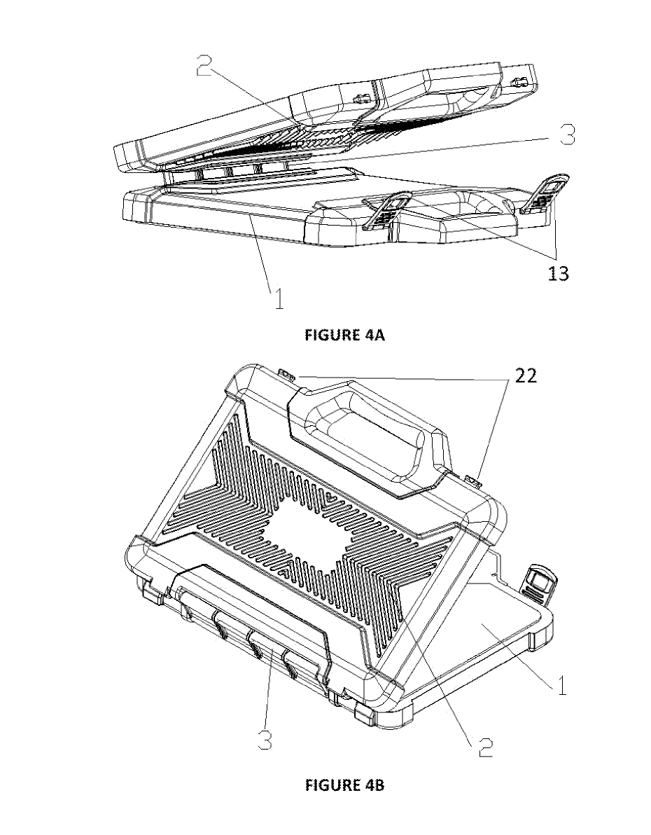

Referring to FIG. 4A and FIG. 4B, according to one embodiment, a top side and a bottom side of the lid 1 have the same structures, and a top side and a bottom side of the body 2 have the same structures. That is the two sides of the lid 1 have the same structures and patterns or designs, the two sides of the body 2 have the same structures and patterns or designs. The tool case is formed even when the lid 1 is rotated 360 degrees to the bottom of the body 2. This feature provides convenience and also extends the life time of the tool case. If one side of the body 2 is damaged, the body 2 can be flipped over to use the other side. Other advantages of the embodiments of the tool case include a smaller footprint or space needed to display the contents of the tool case in either the lid 1 or the body 2. Other advantages of the embodiments of the tool case include a reduced impact on the environment when displaying the contents of the tool case using a transparent material. For example, less materials such as cardboard or ink may be required when displaying or selling the tool case, since the both the lid 1 and the body 2 can support the tool case contents, which can be shown from both the front and back of the tool case when it is in the fully open position.

In one embodiment, the tool case may include one or more hinges to increase the rotational flexibility of the lid 1 and the body 2. In one embodiment, the tool case may include a hinge having two or more pivot points, such as the two pins 4 and 5 illustrated in FIG. 1. The pivot points may be parallel and spaced apart from each other. The longitudinal axis of the pivot points may be perpendicular to the longitudinal axis (e.g. height axis) of the lid 1 and/or body 2. In one embodiment the hinge may include one or more pin connections, living or integral hinge connections, and/or other similar type of rotatable hinge connections. A living or integral hinge connection may be for example a flexible connection formed from or integral with the material used to form the lid 1 and/or the body 2.

While the foregoing is directed to embodiments of the invention, other and further embodiments of the invention may be devised without departing from the basic scope thereof, and the scope thereof is determined by the claims that follow.

1. A tool case for convenient display, comprising:
a lid;
a body; and
a hinge connecting the lid to the body, wherein the lid and the body are rotatable about the hinge and relative to each other through an angle greater than 180 degrees.

2. The tool case of claim 1, wherein the hinge includes one or more pin connections or integral hinge connections.

3. The tool case of claim 1, wherein the hinge includes a connector main body, a first pin, and a second pin, wherein the connector main body has two parallel through holes, wherein the first pin passes through one of the parallel through holes and the lid to form a first pin connection, and wherein the second pin passes through the other one of the parallel through holes and the body to form a second pin connection.

4. The tool case of claim 3, wherein a distance of an axis of the first pin and an axis of the second pin is not less than a half of the summation of a height of the body and a height of the lid.

5. The tool case of claim 3, wherein the hinge further includes a body base and a lid base, wherein the body base is disposed on the body, wherein the lid base is disposed on the lid, and wherein the connector main body is disposed within the body and lid bases.

6. The tool case of claim 5, wherein the body has a first cavity volume at a connecting region, the body base is disposed within the first cavity volume, wherein the body base has a concaved first load slot, wherein the connector main body is connected within the first load slot, and wherein the body base is fixedly coupled to the body via the first pin.

7. The tool case of claim 5, wherein the lid has a second cavity volume at a connecting region, the lid base is disposed within the second cavity volume, wherein the lid base has a concaved second load slot, wherein the connector main body is connected within the second load slot, and wherein the lid base is fixedly coupled to the lid via the second pin.

8. The tool case of claim 1, wherein a top side and a bottom side of at least one of the lid and the body have the same structures.

9. The tool case of claim 1, wherein the hinge includes two or more pivot points.

10. The tool case of claim 1, wherein corresponding handles are positioned on front ends of the body and the lid.

11. The tool case of claim 1, wherein the hinge is operable to rotate the lid relative to the body through an angle up to about 360 degrees.

12. The tool case of claim 1, further comprising:
an inserting member coupled to one of the lid and the body; and
a locking plate member coupled to the other one of the lid and the body, wherein the inserting member engages the locking plate member to lock the lid to the body when the tool case is in a fully open position and when the tool case is in a fully closed position.

13. A tool case for convenient display, comprising:
a lid having an inner surface;
a body having an inner surface; and
a hinge coupled to the lid by a first connection, and coupled to the body by a second connection, wherein the hinge is operable to permit rotation of the lid relative to the body between a closed position wherein the inner surfaces face each other, and an open position wherein the inner surfaces face in opposite directions.

14. The tool case of claim 13, wherein the hinge includes:
a main connector body having a first through hole that is parallel to a second through hole;
a first pin disposed through the first through hole, wherein the first pin engages the lid to thereby form the first pivotable connection; and
a second pin disposed through the second through hole, wherein the second pin engages the body to thereby form the second pivotable connection.

15. The tool case of claim 14, wherein a distance of an axis of the first pin and an axis of the second pin is not less than a half of the summation of a height of the body and a height of the lid.

16. The tool case of claim 14, wherein the hinge further includes:
a lid base coupled to the main connector body and the lid, wherein the first pin is disposed through a spacer plate of the lid base; and
a body base coupled to the main connector body and the body, wherein the second pin is disposed through a spacer plate of the body base.

17. A tool case for convenient display, comprising:
a lid;
a body; and
a hinge pivotably coupled to the lid and the body by separate pivotable connections, wherein the hinge is operable to flip the lid relative to the body such that the lid is engagable with a first side of the body and a second opposite side of the body.

18. The tool case of claim 17, wherein a first pivotable connection is formed by a first pin disposed through one portion of the hinge and the lid, and wherein a second pivotable connection is formed by a second pin disposed through another portion of the hinge and the body.

19. The tool case of claim 18, wherein the first and second pins are disposed parallel to each other.

20. The tool case of claim 18, further comprising a locking connection operable to lock the lid to the body when the lid engages the first side of the body and when the lid is flipped to engage the second opposite side of the body.

21. The tool case of claim 17, wherein the longitudinal axis of the pivotable connections are parallel and spaced apart from each other, and wherein the longitudinal axis of the pivotable connections are perpendicular to the longitudinal axis of the lid and the body.

22. The tool case of claim 17, wherein in the hinge includes two or more pivotable connections.

23. The tool case of claim 17, wherein the hinge includes one or more pin connections or living hinge connections.

24. A method of displaying the contents of a tool case, comprising:
opening the tool case, wherein the tool case includes a lid, a body, and a hinge pivotably connected to the lid and the body;
rotating the lid about 360 degrees relative to the body to a fully open position; locking the lid to the body in the fully open position; and
standing the tool case on the edges of the lid and the body when in the fully open position to display tools supported by at least one of the lid and the body.
